(19) United States
(12) Patent Application Publication
(10) Pub. No.: US 2004/0123666 A1
(43) Pub. Date: Jul. 1, 2004

(54) Ultrasonic damping material

(76) Inventors: Xiaolei S. Ao, Lexington, MA (US); Lawrence C. Lynnworth, Waltham, MA (US); Xuesong Scott Li, Lexington, MA (US)

Correspondence Address: IANDIORIO & TESKA, INTELLECTUAL PROPERTY LAW ATTORNEYS, 260 BEAR HILL ROAD, WALTHAM, MA, 02451-1018, US

(21) Appl. No.: 10/335,493

(22) Filed: Dec. 31, 2002

(51) Int. Cl. G01N 29/04

(52) U.S. Cl. 73/644

(57) ABSTRACT

A damping material for an ultrasonic transducer system includes a spreadable matrix and a plurality of particles is suspended in the spreadable matrix, forming a coating that dissipates ultrasonic energy to dampen noise and reduce crosstalk allowing ultrasonic measurement of gas using clamp-on transducers.

### RELATED APPLICATIONS

This application is related to U.S. patent application Ser. No. 09/539,976 entitled “CLAMP-ON FLOW METER SYSTEM” which is hereby incorporated herein by reference.

### FIELD OF THE INVENTION

This invention relates to a damping material for use, in one example, with ultrasonic flow meter systems, or any ultrasonic transducer system having acoustic impedance mismatches between materials, to reduce noise or crosstalk and improve the signal-to-noise ratio.

### BACKGROUND OF THE INVENTION

The present invention may be used in connection with ultrasonic transducers typically used in flow measurement, and, in one example, for ultrasonic flow measurement wherein a fluid flowing in a conduit is measured by transmitting ultrasonic waves into or across the flow. Such measurement systems are widely used in process control and other situations where fluid measurement is required. The principle of the transit time ultrasonic flowmeter is well known and is widely used in wetted ultrasonic gas and liquid flowmeters as well as in clamp-on liquid flowmeters. In a typical single path configuration, a flowmeter measures flow velocity using two identical angle beam transducers located upstream and downstream from each other on a pipe or conduit. Each transducer typically transmits and receives in an alternating manner so that flow velocity can be calculated based on the transit time sums and differences.

In general, the constraints involved in implementing any such system involve generating a well defined ultrasonic signal, coupling it into the fluid, receiving some portion of the signal after it has traveled through the fluid, and processing the detected signal to determine a parameter of interest such as flow rate, fluid density or the like. Measurement by ultrasonic signal interrogation offers several advantages, including the possibility of performing the measurement without installing specialized measurement cells, without intruding into the fluid or its container, or without causing a pressure drop or flow disturbance in the fluid conduit. When the situation permits the use of a transducer clamped to the outside of the conduit so that no special machining is needed, then the further advantages of installation without interruption of flow, low maintenance cost and portability of the measurement system are obtained.

Clamp-on flow meters, however, generally do not work well with gases due to practical difficulties encountered in signal transmission through the gas/pipe interfaces. The conduit or vessel wall carries noise and may also constitute a significant short circuit signal path between transducers because ultrasonic energy travels directly through the wall of the conduit from the emitting transducer to the receiving transducer. Also, the acoustic impedance mismatch between the conduit or vessel wall and the fluid, such as between a metal pipe and gas, is generally so great that only a very small fraction of the acoustic energy can be transmitted through the pipe/gas interfaces. The characteristic acoustic impedance of a medium is Z, where Z is the product of the density ρ and sound speed c of the medium. Air at atmospheric pressure provides a Z value of only 6×10⁻⁴ Mrayls, whereas water has a Z value of about 1.5 Mrayls. The orders-of-magnitude difference in Z between water and air explains the fact that most liquid flow (e.g. water) in typical pipe conditions can be easily measured non-intrusively using an ultrasonic flow meter while low pressure gas or air flow in metal pipes is considered by those skilled in the art to be nearly impossible to measure using a conventional clamp-on ultrasonic transit time flow meter. When the fluid has very low density, such as steam, gas or air, it carries very little signal energy compared to that in the pipe wall. Acoustic impedance mismatch means the energy transmission coefficient from steel to fluid, and vice versa, is small, resulting in passage of an extremely weak signal across the desired path in the fluid. Especially when the fluid to be measured is of low density, such as steam at low pressure, lower molecular weight hydrocarbon liquids, or flare gas at atmospheric pressure, the foregoing factors all apply, and the low-intensity, weak acoustic signal across the fluid together with the high level of conduit short circuit noise call for means to dampen the noise or crosstalk carried by the conduit or vessel wall that interferes with the signal.

Typically, the energy transmitted through the pipe or conduit, then through the gas, and from the gas and back into the pipe, carries flow information that is defined as signal; the rest is noise or crosstalk. The crosstalk noise is coherent, staying in the same frequency band as the signal. It generally arrives earlier than the signal due to the higher sound speed in metal. In the case of liquid flow through a pipe, the signal-to-noise ratio (SNR) is much higher so that proper windowing in time is adequate enough for accurate timing. In gas flow, the amplitude of crosstalk is high and rings for such a long time that it buries the signal carrying flow information. This type of poor SNR is also encountered sometimes in clamp-on liquid flow measurement but on a much smaller scale, i.e. not as problematic. These drawbacks limit the clamp-on configuration to an odd number of traverses, where the transmitter and receiver sit on the opposite sides of the pipe. The precise configuration of U.S. patent application Ser. No. 09/539,976, incorporated herein by reference, results in reduction of noise and crosstalk. It is desirable to reduce noise and crosstalk even further, however. This is especially so for purposes of gas flow measurement, because multi-reflection caused by any inhomogeneity in the piping system can bounce back and arrive at the receiver with much higher amplitude than the desired signal and thus interfere with the flow measurement. Flanges and pipe-fittings are examples of such inhomogeneities in the piping system.

Acoustic damping materials that have been applied to the region of the conduit wall between the transducers to reduce crosstalk include ultrasound coupling gel of suitable temperature rating, or high-temperature polymers such as rubber or a rubber and tar mixture. Other materials such as lead or lead tape, epoxy, and metal have also been used. None of these materials have proven to provide adequate damping. Also, lead generally cannot be used due to safety concerns. While metal presents a good Z match, it adds weight to the system. Rubber and epoxy do not satisfactorily remove ultrasonic energy from metal pipe. Moreover, all of these known damping materials are difficult to apply and conform to a pipe or conduit and must be glued or otherwise coupled and attached to the conduit, and often present clean up or removal concerns. The latter is especially true for damping materials used with portable clamp-on flow meters, where it is undesirable to leave a residue on the conduit or pipe after measurements have been completed. Also, known damping materials are relatively expensive.

Another proposed solution used in reducing crosstalk is to place a damping material having a Z value similar to the pipe between the two transducers by applying a heavy load on the pipe to suppress the amplitude of the pipe vibration, such as a Ruland two-piece collar or clamp, or a partially hollow clamp having cavities filled with tungsten powder and epoxy. While such a system has shown some reductions in the crosstalk, its disadvantage is that it sometimes introduces additional noises within a certain time window. The expense, complexity and the installation of such devices are also disadvantageous.

### BRIEF SUMMARY OF THE INVENTION

It is therefore an object of this invention to provide an improved damping material for use in connection with ultrasonic transducers and flow meter systems.

It is a further object of this invention to provide such a damping material that reduces noise and crosstalk.

It is a further object of this invention to provide such an improved ultrasonic flow meter that improves the signal-to-noise ratio (SNR).

It is a further object of this invention to provide such a damping material that is safe and has relatively low cost.

It is a further object of this invention to provide such a damping material that is relatively lightweight, which is spreadable and readily conformable to a pipe or conduit and which is easily removable.

It is a further object of this invention to provide such a damping material which now makes it possible to measure the characteristics of a gas in a conduit more easily via clamp-on ultrasonic transducers.

This invention results from the realization that by using a damping material exhibiting high inhomogeneity, high density, conformability, malleability, and easy application and removal allows the characteristics of a gas in a conduit to be more easily measured using clamp-on ultrasonic transducers.

This invention features damping material for an ultrasonic transducer system. The damping material includes a spreadable matrix and a plurality of particles suspended in the spreadable matrix forming a coating for dissipating ultrasonic energy to dampen noise and reduce crosstalk. The spreadable matrix may include a liquid, wax, grease, oil or any combination of these.

Preferably, the particles have a size less than 50 micrometers. The particles are chosen in a size to be in the range of 0.1 to 1 times a wavelength of interest, where a wavelength of interest is the wavelength desired or typically used in clamp-on gas flow meter measurement systems. Examples of particles include clay powder, aluminum oxide, or calcium carbonate. The particles typically constitute between 80%-85% by weight of the damping material. The spreadable matrix material typically constitutes between 15-20% by weight of the damping material. The particles preferably have a crystalline structure. In one embodiment, the damping material has a density in the range of 0.7 to 5 g/cc. Preferably, the damping material has a density of about 2 g/cc.

This invention further features an ultrasonic measurement system including a conduit, at least one ultrasonic transducer coupled to the conduit proximate the transducer, and damping material disposed about the conduit proximate the transducer. In one example, the damping material includes a spreadable matrix and a plurality of particles suspended in the matrix forming a coating for dissipating unwanted ultrasonic energy in the system to dampen noise and reduce crosstalk. The transducer may be a clamp-on transducer or a wetted transducer. The spreadable matrix may include a liquid, wax, grease, oil, or any combination of these.

The particles may have a size less than 50 micrometers, and may constitute 80%-85% by weight of the damping material. The plurality of particles may have a crystalline structure. The particles may be chosen in size to be in the range of 0.1 to 1 times a wavelength of interest, and may include clay powder, aluminum oxide, or calcium carbonate. The damping material may have a density in the range of 0.7 to 5 g/cc, preferably about 2 g/cc. The ultrasonic transducer may include a waveguide, and the damping material may be disposed about the waveguide or about the waveguide and the pipe.

This invention also features a flow analysis method which includes coupling an ultrasonic transducer to a conduit for analyzing a flow in the conduit and disposing about the conduit proximate the transducer a damping material. The damping material may include a spreadable matrix and a plurality of particles suspended in the spreadable matrix, forming a coating for dissipating unwanted ultrasonic energy in the system to dampen noise and reduce crosstalk. The transducer may be a clamp-on transducer or a wetted transducer. The spreadable matrix may include a liquid, wax, grease, oil or any combination of these.

The invention also features a flow analysis method including coupling a waveguide of an ultrasonic transducer to a conduit for analyzing a flow in the conduit, and disposing about the waveguide a damping material. The damping material may include a spreadable matrix and a plurality of particles suspended in the spreadable matrix, forming a coating to eliminate multi-reflections at the waveguide/conduit interface.

This invention also features a liquid level or density analysis system including coupling at least one transducer to a container and disposing about the container proximate the transducer a damping material forming a coating including a spreadable matrix and a plurality of particles suspended in the spreadable matrix. The damping material may be disposed between the at least one transducer and a second transducer to verify performance of the system by modulating propagation of elastic waves in a wall of the container.

### BRIEF DESCRIPTION OF THE DRAWINGS

Other objects, features and advantages will occur to those skilled in the art from the following description of a preferred embodiment and the accompanying drawings, in which:

FIG. 1 is a schematic view of a typical clamp-on flow measurement configuration showing transducers located on the same side of a conduit;

FIG. 2 is a schematic view of another typical clamp-on flow measurement configuration showing transducers located on opposite sides of a conduit;

FIG. 2A is a schematic cross-sectional view of a conduit showing energy traveling along the conduit circumferentially;

FIG. 3 is a schematic view of a typical clamp-on flow meter system including two transducers but without any damping material between the transducers;

FIG. 4 is a graph showing the waveform received from the system of FIG. 3 with no damping;

FIG. 5 is a schematic view of one example of the damping material of the present invention applied on a conduit between two clamp-on transducers of a typical clamp-on flow meter system in order to measure the characteristics of a gas flowing in the conduit;

FIG. 6 is a graph showing the waveform when damping material according to the present invention is applied between the transducers in the system of FIG. 5;

FIG. 7 is a graph showing air flow rate and sound speed measurement using a commercially available clamp-on flow meter on a 6″ diameter carbon steel pipe when the damping material of this invention is applied;

FIG. 8 is a photomicrograph of the damping material shown in FIG. 5;

FIG. 9 is a schematic view of an ultrasonic transducer of the present invention clamped onto a conduit;

FIG. 10 is a schematic view of the damping material of this invention in conjunction with metal or ceramic waveguide surfaces;

FIG. 11 is a graph showing a signal through air for the waveguide shown in FIG. 10 without, and with, the damping material of this invention;

FIG. 12 is a schematic view of a waveguide coated with damping material and clamped onto a conduit in accordance with this invention;

FIG. 13 is a schematic view of a container coated with damping material according to this invention; and

FIG. 14 is another schematic view of a container coated with damping material according to this invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

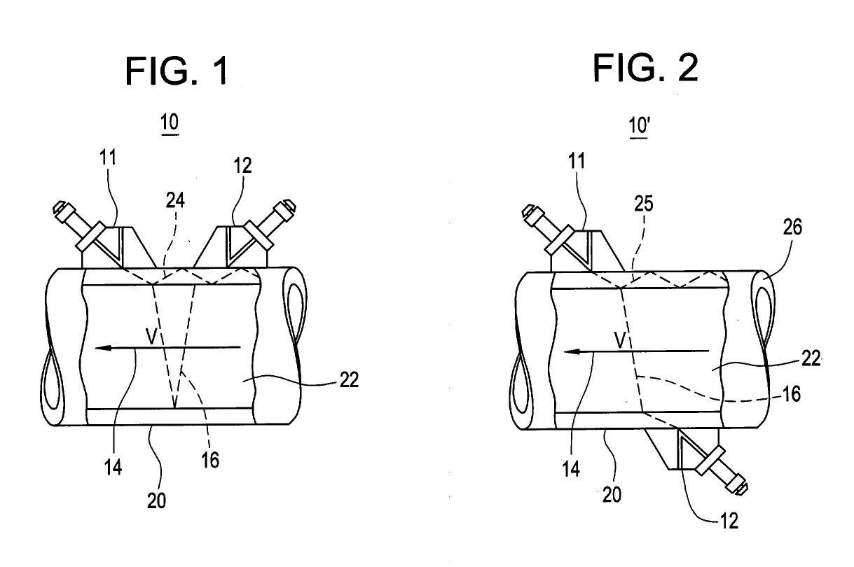

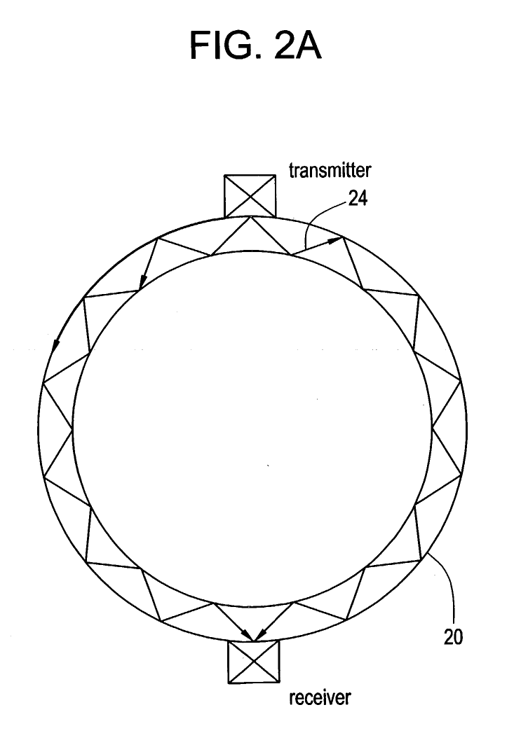

Typical clamp-on flow measurement configurations 10, 10′ are shown in FIGS. 1 and 2, where the configuration of FIG. 1 sometimes preferred for convenience and better accuracy. When transducer 12 serves as receiver, it receives acoustic energy launched by transducer 11 through different paths. As shown by example in FIGS. 1 and 2, flow 14 is denoted by V. The paths of signals 16 are shown in FIGS. 1 and 2 for each of these transducer configurations.

As noted in the Background section above, the energy can be defined or considered as being partitioned into two parts. The energy 16 transmitted through pipe 20 to gas 22 flowing therein carries flow information and is defined as the signal. The rest of the energy is defined as noise or crosstalk. Crosstalk 24, FIG. 1, and noise 25, FIG. 2 are coherent, staying in the same frequency band as signal 16, generally arriving earlier at receiving transducer 12 than signal 16 due to the higher sound speed in conduit 20, which is typically metal. In the case of liquid flow V in pipe 20, the signal-to-noise ratio (SNR) is much higher so that proper windowing in time is adequate enough for accurate timing. However, in a gas flow, the amplitude of crosstalk 24 and noise 25 is high, and rings for a long period of time in conduit 20 such that it buries signal 16 that carries flow information. This type of poor SNR is sometimes encountered in clamp-on liquid flow measurement, but on a much smaller scale.

The poor SNR limits the clamp-on gas flow measurement at low pressure to an odd number of traverses of signal 16 in the configuration of 10′ where transmitter 11 and receiver 12 sit on the opposite sides of pipe 20 as shown in FIG. 2. Despite a major reduction of crosstalk energy 24 in this configuration, noise 25 traveling through pipe wall 26, shown in FIG. 2, and the part of the energy 24 traveling along pipe 20 circumferentially (shown in FIG. 2A) may still result in some crosstalk 24 and noise 25 due to the higher acoustic impedance mismatch between gas 22 and pipe 20 and because multi-reflection caused by any inhomogeneities in the pipe can bounce back and arrive at receiver 12 with a much higher amplitude than signal 16.

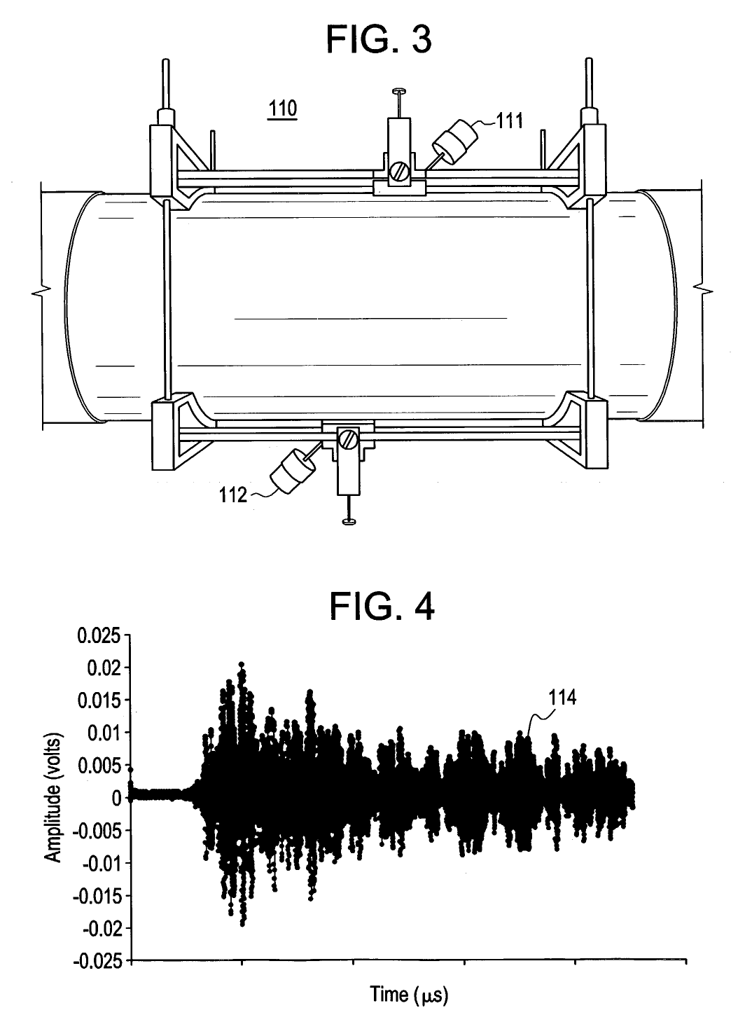

When transducer 111, of clamp-on flow meter system 110 transmits a tone burst signal to transducer 112, FIG. 3, through air in the pipe at ambient pressure, waveform 114 received by transducer 112 is shown in FIG. 4 when there is no damping material applied, and the crosstalk and noise effectively buries the signal carrying flow information.

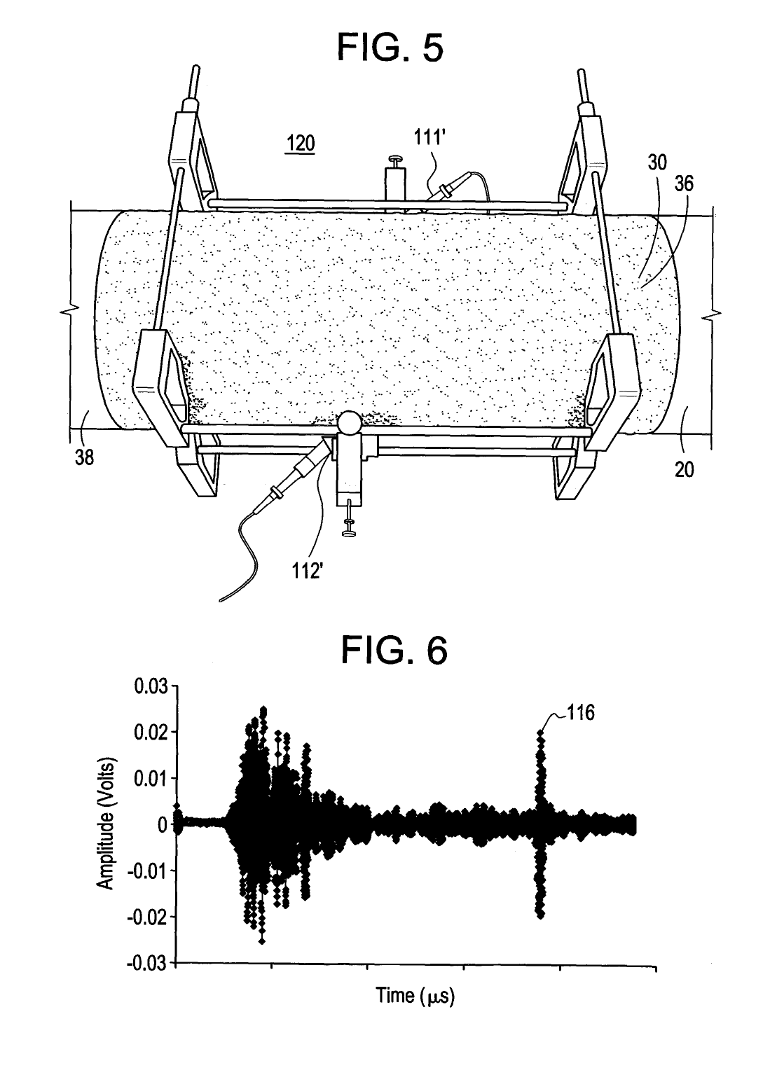

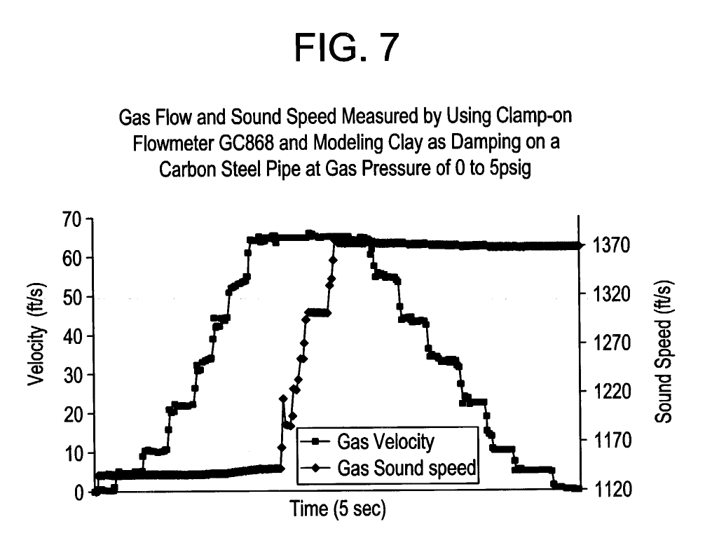

In contrast, when damping material 30 in accordance with this invention, FIG. 5, is used on conduit 20 carrying air at atmospheric pressure, waveform 116, FIG. 6, was obtained, resulting in a much cleaner signal. Damping material 30 can also be used in conjunction with configuration of FIG. 1 where both transducers 11 and 12 are on the same side of pipe or conduit 20. In measurements performed using the damping material of this invention, air flow was measured using configuration 10′, FIG. 1, at pressure as low as 30 psig, which allows the measurement system to be more accurate. When the damping material of this invention was applied to a 6 inch diameter steel pipe as in FIG. 5, for example, a GE Panametrics commercial clamp-on flow meter model GC868 measured air flow and sound speed from approximately 0 to 64 feet per second (approximately 0 to 20 m/s) at ambient pressure, as shown in FIG. 7. It also measured flow velocity and sound speed after helium gas was introduced into the pipe. Gas sound speed (at known temperature) has been used to monitor mean molecular weight of flare gas in flare stacks at essentially atmospheric pressure by the known wetted method since the 1980s, but with the damping material of this invention the mean molecular weight inside a metal pipe can be measured non-intrusively even at such a low pressure. One new and useful result is now the ability to use clamp-on flow meters to more easily analyze a gas flow in a conduit.

Because damping is an important way to eliminate noise, the method of implementing damping can be very critical. Simple heavy mass loading by a non-absorptive structure such as a two-piece collar or clamp (manufactured by Ruland Manufacturing Company of Watertown, Massachusetts, and by others) with good impedance match still can release some crosstalk energy into the damping region and release it back into the pipe at a later time, thus interfering with the measurement.

The applicants have discovered that the most efficient way to remove crosstalk and noise is to select a damping material a) with high inhomogeneity and including particles of the appropriate size in relation to a wavelength of interest resulting in attenuation and dispersion of ultrasonic waves; b) with high density; and c) which is readily conformable and attachable to, and removable from, a conduit or pipe. Also, it is preferred that the damping material contains no toxins such as lead or asbestos, and that the material be compatible with high temperature applications.

The first feature requires a multi-component material containing inhomogeneities, preferably of a size of approximately 0.1 to 1 times of the wavelength of the ultrasonic signal, typically from less than one micrometer to 50 micrometers, with particles such as clay powder. Particles of this size are very attenuative to both shear and longitudinal waves because they cause Rayleigh scattering of the ultrasonic waves. Frequencies typically used in clamp-on gas flow meter measurement systems are in the range of 0.1 to 5.0 MHz.

Moreover, the plurality of particles of the given size appear to absorb the noise causing ultrasonic wave signal in the pipe, by a mechanism which may be due to the polycrystalline structure of the particles, and possibly by the particles converting the ultrasonic sound wave to thermal energy due to molecular interactions in the crystal lattice. These factors may explain why other groups of similar materials, such as aluminum oxide and magnesium oxide compounds, for example, may also be used for damping in accordance with the present invention.

One example of such a clay powder is plasticene or plastelene, known by its brand name of Van Aken modeling clay and manufactured by Van Aken International of California. This modeling clay includes calcium carbonate or limestone suspended in wax. Wax or grease such as high temperature grease or synthetic polymers, or mineral oil, or any combination of wax, grease, synthetic polymers or oil, may be used in connection with the present invention, depending on temperature needs for a particular transducer system. Preferably, the plurality of particles will be in the range of 80-85% of the total weight of the material, with the remaining 15-20% comprising the wax, grease, oil and/or synthetic polymer.

Another commercially available compound exhibiting such properties and which may be used as a damping material in accordance with this invention is FlameSafe® FSP 1000/FSP Firestop Putty, which contains aluminum oxide, and is manufactured by W. R. Grace & Co. of Connecticut. Previously, this material was used to stop spread of fire by, for example, sealing openings around electrical cables, electrical boxes, and electrical conduits. This material can withstand pipe temperatures of at least 450° F., and its high temperature compatibility is particularly suited for use with ultrasonic gas flow measurement systems discussed herein for high temperature pipes, i.e. for steam flow metering. Another material exhibiting the foregoing properties is Babbitrite retaining compound sold by McMaster-Carr of New Jersey.

The second feature requires that the material have a density of 1-50% of the density of the metal pipe or conduit, and typically such a value is in the range of 0.7 to 5 g/cc for metal pipe, preferably approximately 2 g/cc. Densities near the upper end of this range are high compared to most other non-metal engineering materials. The third feature requires that the material be pliable and easy to work with in the field by way of ease of application and removal from the pipe or conduit containing the flow sought to be measured.

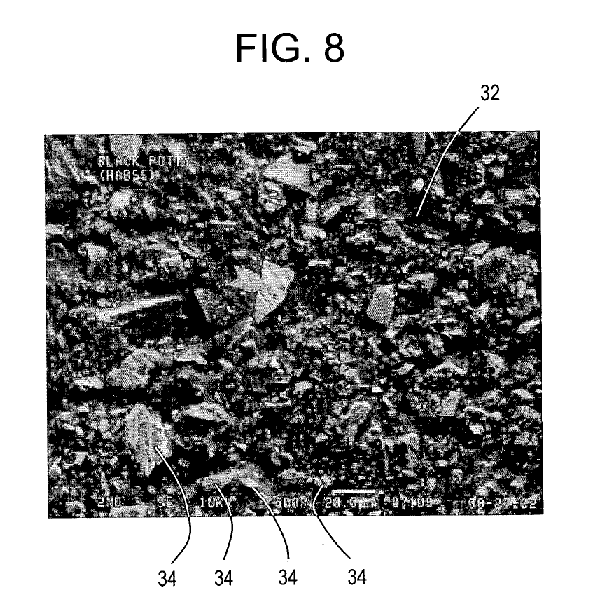

The damping material 30, of this invention includes spreadable matrix 32, FIG. 8, and a plurality of particles 34 suspended in spreadable matrix 32 forming coating 36, FIG. 5, for dissipating unwanted ultrasonic energy in the system to dampen noise and reduce crosstalk in conduit or pipe 20. Spreadable matrix 32, FIG. 8, may be spread onto and around conduits 20 to form coating 36 that is malleable and workable in the field and that maybe applied and removed by hand.

Spreadable matrix 32 is typically a liquid, wax, grease, oil, or any combination thereof. In one embodiment, particles 34 may have a size less than 50 micrometers, and particles 34 may constitute 80-85% by weight of damping material 30. Preferably, particles 34 have a crystalline structure. Particles 34 may be chosen in size to be in the range of 0.1 to 1 times a wavelength of interest. Particles 34 may be clay powder, aluminum oxide, or calcium carbonate. In one embodiment, damping material 30 has a density in the range of 0.7 to 5 g/cc. In a preferred embodiment, damping material 30 has a density of about 2 g/cc.

The preferred damping material of this invention is pliable and readily conformable to a pipe, typically a metal pipe, comprising between about 80-85% by weight of inhomogenous particles 34 and between 15-20% by weight spreadable matrix 32.

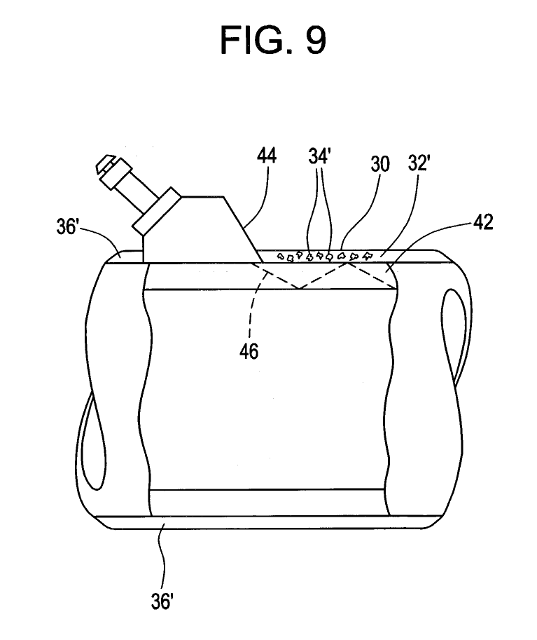

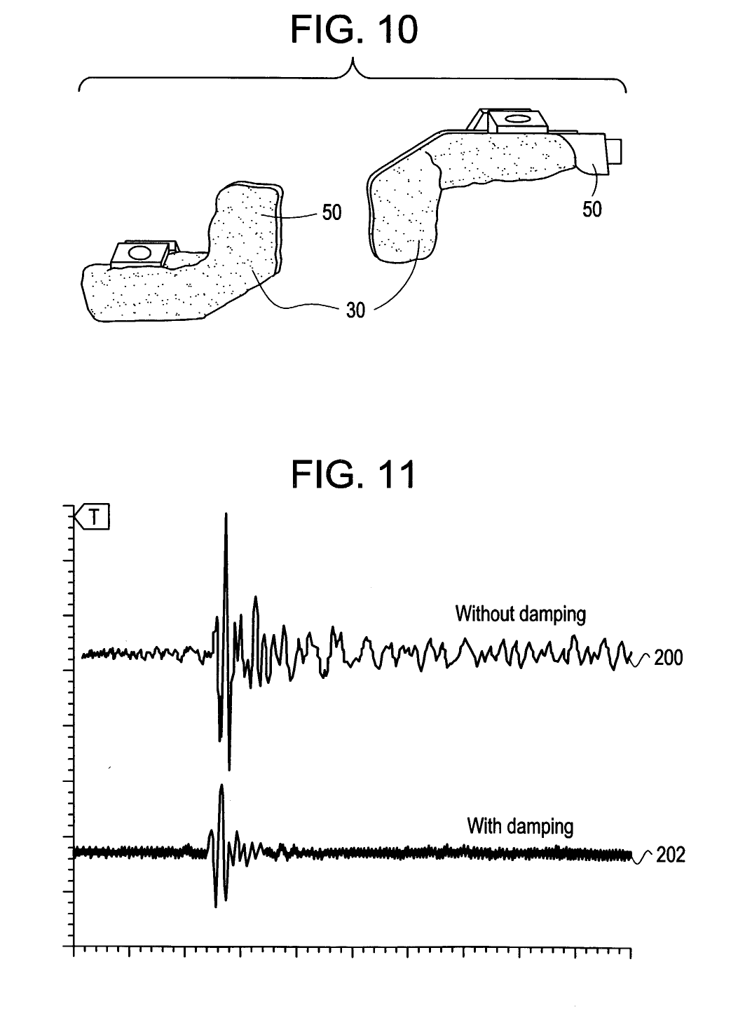

One example of an ultrasonic transducer system of this invention includes conduit 42, FIG. 9, at least one transducer 44 coupled to conduit 42, and damping material 30 disposed about conduit 42 at least in the vicinity of transducer 44. Transducer 44 may be a clamp-on transducer, as shown, or a wetted transducer (not shown). Ultrasonic transducer 44 may include waveguide 50, FIG. 10, with damping material 30 also disposed about waveguide 50. FIG. 11 illustrates a 500 kHz signal transmitted through air using waveguide 50, FIG. 10. Waveform 200 was obtained without the damping material applied. Waveform 202 was obtained with the damping material applied according to this invention. Particularly, the damping material applied to obtain waveform 202 was is FlameSafe® FSP 1000/FSP Firestop Putty. It will be understood by those skilled in the art that analyzing flow includes determination of associated parameters which may include sound speed measurements, fluid density measurements and the like. It will also be understood that the damping material of the present invention may be used in systems where transducers are located on the same side of a conduit, one transducer systems, or any system where damping of noise or crosstalk is necessary or desired. This includes ultrasonic flow measuring systems having only one transducer, e.g., Doppler or stroboscopic scattering (speckle tracking) systems.

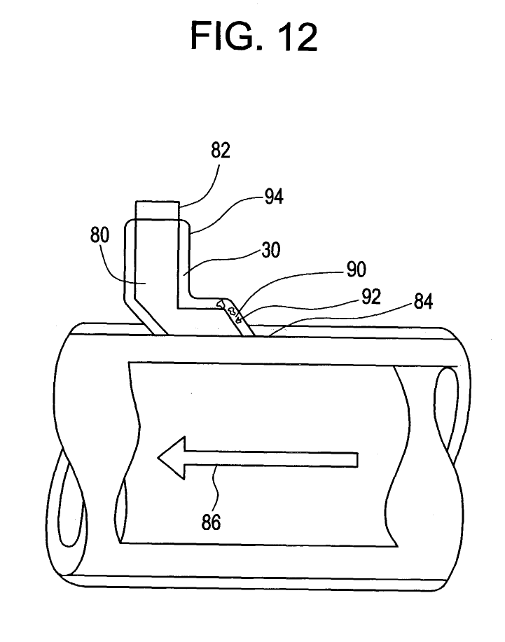

In another embodiment, the flow analysis method of this invention includes coupling waveguide 80, FIG. 12, of ultrasonic transducer 82 to conduit 84 for analyzing flow 86 in conduit 84, and disposing about waveguide 80 damping material 30. See also FIG. 10. Damping material 30 dissipates ultrasonic energy to eliminate multi-reflections at the waveguide/conduit interface.

The use of the damping material of this invention is not limited to clamp-on transit time (contrapropagation) flow meter measurements, but may also be used to improve SNR for other types of ultrasonic flow meters such as cross-correlation flow meters where such a system often uses continuous waves (CW) and generally uses two pairs of transducers. The damping material of this invention may also be used to eliminate reflection of CW waves from flanges and reduce cross talk between the two pairs of transducers, thus providing for broader applications for such a system. The damping material of this invention may be used for transducer fabrication to eliminate unwanted acoustic energies. Additionally, the damping material of the present invention may be used as backing material to achieve broad band signals, or applied to metal or ceramic wave guide surfaces to eliminate multi-reflections at the interface of the wave guide and surrounding mediums to obtain a clean signal for time of flight measurement by either transmission or pulse-echo, as shown by way of example in FIGS. 10, 11 and 12. As such, it speeds up the response time by allowing higher pulse repetition frequencies to be employed.

In addition to such systems as noted herein, the damping material of this invention can be used on any metal surfaces to eliminate unwanted ultrasonic signals, including but not limited to wetted applications where the transducers contact the flow, nonflow applications such as clamp-on pressure measurements, sound speed measurements and the like.

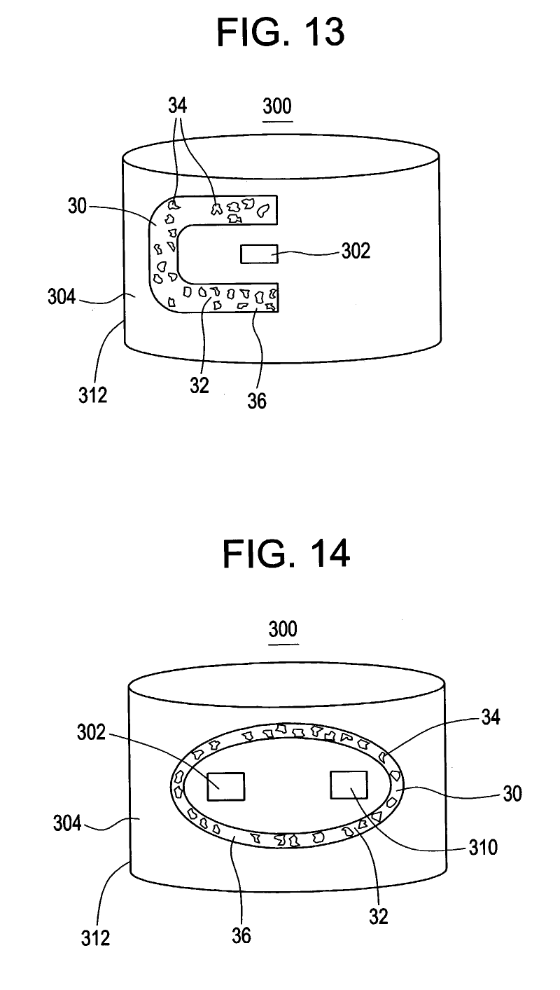

The damping material of this invention may also be used around or between transducers such as those used in liquid level, fluid impedance or density analysis systems for fluids in containers or conduits. Examples of such systems include a shear elastic wave measuring apparatus such as the apparatus described in U.S. Pat. No. 4,320,659 to Lynnworth et al., and the flexural elastic wave measuring apparatus such as the apparatus described in U.S. Pat. No. 5,456,114 to Liu et al., both of which are incorporated herein by reference. The purposes of the damping material in such systems include noise reduction and/or verifying calibration and system general operation and performance. When temporarily coupled between a pair of flexural transducers as described in U.S. Pat. No. 5,456,114, the damping material of this invention attenuates and/or slows down the propagation of flexural elastic waves in the container or conduit. In one example, liquid level or density analysis system 300, FIG. 13, includes coupling at least one transducer 302 to container or conduit 304, and disposing about container 304 proximate transducer 302 damping material 30 forming coating 36 which includes spreadable matrix 32 and a plurality of particles 34 suspended in spreadable matrix 32 to reduce noise, to verify calibration, to evaluate system general operation and performance, or any combination of these, by attenuating propagation of elastic waves in wall 312 of container 304. Damping material 36 may be disposed between the at least one transducer 302 and second transducer 310, FIG. 14, to verify performance of the system by influencing or modulating the complex propagation constant of elastic waves in wall 312 of container 304. For zigzagging shear waves the verification may be primarily or exclusively attenuating effects, while for the flexural systems the effects may be primarily or exclusively the delaying of propagation, i.e. slowing the propagation velocity, caused by mass loading of the wall of the container or conduit by the damping material when that material is coupled to the wall. Applying the damping material temporarily is functionally similar to filling the container or reservoir of the elastic wave sensing system of U.S. Pat. No. 5,456,114, to load the wall externally, simulating the mass loading by a liquid adjacent the inside surface of the wall.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. For example, the damping material may also be used in connection with systems for analyzing the flow of a liquid in a conduit or for characterizing a conduit itself.

Other embodiments will occur to those skilled in the art and are within the following claims:

What is claimed is:

1. A damping material for an ultrasonic measurement system, the damping material comprising:
a spreadable matrix; and
a plurality of particles suspended in the spreadable matrix forming a coating to dampen noise and reduce crosstalk.

2. The damping material of claim 1 wherein the spreadable matrix includes a liquid.

3. The damping material of claim 1 in which the spreadable matrix includes wax.

4. The damping material of claim 1 in which the spreadable matrix includes grease.

5. The damping material of claim 1 in which the spreadable matrix includes oil.

6. The damping material of claim 1 wherein the particles have a size less than 50 micrometers.

7. The damping material of claim 1 wherein the particles constitute 80%-85% by weight of the damping material.

8. The damping material of claim 1 wherein the plurality of particles have a crystalline structure.

9. The damping material of claim 1 having a density in the range of 0.7 to 5 g/cc.

10. The damping material of claim 1 having a density of about 2 g/cc.

11. The damping material of claim 1 in wherein the particles have a size in the range of 0.1 to 1 times a wavelength of interest.

12. The damping material of claim 1 in which the particles are clay powder.

13. The damping material of claim 1 in which the particles are aluminum oxide.

14. The damping material of claim 1 in which the particles are calcium carbonate.

15. A damping material for an ultrasonic measurement system, the damping material comprising:
a spreadable matrix; and
a plurality of particles suspended in the spreadable matrix forming a coating having a density in the range of 0.7 to 5 g/cc to dampen noise and reduce crosstalk.

16. A damping material for an ultrasonic measurement system, the damping material comprising:
a spreadable matrix; and
a plurality of particles each having a size less than 50 micrometers and suspended in the spreadable matrix forming a coating to dampen noise and reduce crosstalk.

17. A damping material for an ultrasonic measurement system, the damping material comprising:
a spreadable matrix selected from the group consisting of wax, grease, oil, liquid and synthetic polymers; and
a plurality of particles suspended in the spreadable matrix forming a coating to dampen noise and reduce crosstalk.

18. A damping material for an ultrasonic measurement system, the damping material comprising:
a spreadable matrix selected from the group consisting of wax, grease, oil, liquid and synthetic polymers; and
a plurality of particles each having a size less than 50 micrometers and suspended in the spreadable matrix forming a coating having a density in the range of 0.7 to 5 g/cc to dampen noise and reduce crosstalk.

19. A pliable, conformable damping material for an ultrasonic measurement system to attenuate noise and reduce crosstalk, the damping material comprising:
between about 80 and 85% by weight particles; and
between about 15 and 20% by weight spreadable matrix.

20. The damping material of claim 19 in which the inhomogenous particles have a size less than 50 micrometers.

21. The damping material of claim 19 in which the particles have a size to be in the range of 0.1 to 1 times a wavelength of interest.

22. The damping material of claim 19 having a density in the range of 0.7 to 5 g/cc.

23. The damping material of claim 19 having a density of about 2 g/cc.

24. The damping material of claim 19 in which the spreadable matrix is grease.

25. The damping material of claim 19 in which the spreadable matrix is oil.

26. The damping material of claim 19 in which the spreadable matrix is wax.

27. The damping material of claim 19 in which the spreadable matrix is a liquid.

28. An ultrasonic measurement system comprising:
a conduit;
at least one ultrasonic transducer coupled to the conduit;
damping material disposed about the conduit proximate the at least one transducer, the damping material comprising:
a spreadable matrix; and
a plurality of particles suspended in the matrix forming a coating to dampen noise and reduce crosstalk.

29. The ultrasonic measurement system of claim 28 in which the at least one transducer is a clamp-on transducer.

30. The ultrasonic measurement system of claim 28 in which the at least one transducer is a wetted transducer.

31. The ultrasonic measurement system of claim 28 wherein the spreadable matrix includes a liquid.

32. The ultrasonic measurement system of claim 28 in which the spreadable matrix includes wax.

33. The ultrasonic measurement system of claim 28 in which the spreadable matrix includes grease.

34. The ultrasonic measurement system of claim 28 in which the spreadable matrix includes oil.

35. The ultrasonic measurement system of claim 28 wherein the particles have a size less than 50 micrometers.

36. The ultrasonic measurement system of claim 28 wherein the particles constitute 80%-85% by weight of the damping material.

37. The ultrasonic measurement system of claim 28 wherein the plurality of particles have a crystalline structure.

38. The ultrasonic measurement system of claim 28 wherein the damping material has a density in the range of 0.7 to 5 g/cc.

39. The ultrasonic measurement system of claim 28 wherein the damping material has a density of about 2 g/cc.

40. The ultrasonic measurement system of claim 28 in wherein the particles are chosen in size to be in the range of 0.1 to 1 times a wavelength of interest.

41. The ultrasonic measurement system of claim 28 wherein the particles include clay powder.

42. The ultrasonic measurement system of claim 28 wherein the particles include aluminum oxide.

43. The ultrasonic measurement system of claim 28 wherein the particles include calcium carbonate.

44. The ultrasonic measurement system of claim 28 wherein the ultrasonic transducer includes a waveguide.

45. The ultrasonic measurement system of claim 44 wherein the damping material is disposed about the waveguide.

46. A flow analysis method comprising:
coupling an ultrasonic transducer to a conduit to analyze a gas flow in the conduit; and
disposing about the conduit proximate the transducer a damping material including a spreadable matrix and a plurality of particles suspended in the spreadable matrix forming a coating about the conduit to dampen noise and reduce crosstalk.

47. The method of claim 46 in which the transducer is a clamp-on transducer.

48. The method of claim 46 in which the transducer is a wetted transducer.

49. The method of claim 46 wherein the spreadable matrix includes a liquid.

50. The method of claim 46 in which the spreadable matrix includes wax.

51. The method of claim 46 in which the spreadable matrix includes grease.

52. The method of claim 46 in which the spreadable matrix includes oil.

53. The method of claim 46 wherein the particles have a size less than 50 micrometers.

54. The method of claim 46 wherein the particles constitute 80%-85% by weight of the damping material.

55. The method of claim 46 wherein the plurality of particles have a crystalline structure.

56. The method of claim 46 wherein the damping material has a density in the range of 0.7 to 5 g/cc.

57. The method of claim 46 wherein the damping material has a density of about 2 g/cc.

58. The method of claim 46 wherein the particles are chosen in size to be in the range of 0.1 to 1 times a wavelength of interest.

59. The method of claim 46 wherein the particles are clay powder.

60. The method of claim 46 wherein the particles are aluminum oxide.

61. The method of claim 46 wherein the particles are calcium carbonate.

62. A flow analysis method comprising:
coupling the waveguide of an ultrasonic transducer to a conduit for analyzing a flow in the conduit; and
disposing about the waveguide a damping material including a spreadable matrix and a plurality of particles suspended in the spreadable matrix forming a coating to eliminate multi-reflections at the waveguide/conduit interface.

63. A liquid level analysis system comprising:
coupling at least one transducer to a container; and
disposing about the container proximate the at least one transducer a damping material forming a coating including a spreadable matrix and a plurality of particles suspended in the spreadable matrix.

64. The liquid level analysis system of claim 63 wherein the damping material is disposed between the at least one transducer and a second transducer to verify performance of the system by modulating propagation of elastic waves in a wall of the container.

65. A density analysis system comprising:
coupling at least one transducer to a container; and
disposing about the container proximate the at least one transducer a damping material forming a coating including a spreadable matrix and a plurality of particles suspended in the spreadable matrix.

66. The density analysis system of claim 63 wherein the damping material is disposed between the at least one transducer and a second transducer to verify performance of the system by modulating propagation of elastic waves in a wall of the container.
